(19) United States
(12) Patent Application Publication
(10) Pub. No.: US 2017/0302627 A1
(43) Pub. Date: Oct. 19, 2017

(54) A METHOD AND SYSTEM FOR DELIVERY CONTEXT-RELEVANT CONTENT TO PORTABLE DEVICES

(71) Applicant: WITTOS LTD, London (GB)

(72) Inventors: Amy May, Yenn LAI, London (GB); Marius Constantin RARINCA, Cluj-Napoca, Cluj (RO)

(21) Appl. No.: 15/511,810

(22) PCT Filed: Sep. 16, 2015
(86) PCT No.: PCT/GB2015/000266

§ 371 Date: Mar. 16, 2017

Related U.S. Application Data
(60) Provisional application No. 62/051,001, filed on Sep. 16, 2014.

(51) Int. Cl. H04L 29/06; G06Q 50/00

(52) U.S. Cl. CPC H04L 63/0245; G06Q 50/01

(57) ABSTRACT

The present invention addresses the problem of targeting advertisements to be displayed on customers' mobile devices who move through a physical location. A method for dynamic delivery of content to a user's portable device connected to an access point is disclosed which includes the steps of: analysing network traffic sent from the portable device via the access point; generating a profile for the user based at least in part upon the analysed network traffic and the location of the portable device; matching content to the user profile; and delivering the matched content to the portable device. A system for dynamically delivering content is also disclosed.

### FIELD OF INVENTION

The present invention is in the field of content delivery. More particularly, but not exclusively, the present invention relates to dynamic content delivery to portable devices.

### BACKGROUND

The increasing availability and uptake of smart mobile devices offering broadband connectivity has increased demand for a smarter indoor venue experience, for example, in the retail industry there is a desire for a means for bricks and mortar retailers to connect to and engage with their customers.

Whilst analytics of traditional Internet user behaviour has matured, and a myriad of solutions offering insight and engagement have evolved, no comparable solutions exist to offer retailers real-time analytical insight and reaction capability into a customer's online behaviour whilst inside their premises.

Existing products are fragmented in approach and ability to deliver insight on user behaviour (show-rooming). These products can be categorised into three groups:

### Captive Portal Vendors

A captive portal forces an HTTP client on a network to see a special web page before using the Internet normally. This is done by intercepting most packets, regardless of address or port, until the user opens a browser and tries to access the web. At that time the browser is redirected to a web page which may require authentication and/or payment, or simply display an acceptable use policy and require the user to agree. Captive portals are used at many Wi-Fi hotspots, and can be used to control wired access as well.

There are several captive portal providers however most of these are limited in that they are linked to personal named account information. The primary goal of these services are to target users known by name, captured from a service registration form, CRM system or social login account. These services mine users' profiles offline or serve ads to specific demographic profiles, typically from 3^{rd} party ad networks. Several of these offer analytics limited to usage of the captive portal itself.

### Footfall Traffic Analytics

Footfall within physical venues is typically measured using a plurality of CCTV (close-circuit television) cameras which are used to count individuals passing by in specific areas of the venue.

Several products exist that offer analytics of footfall traffic; these products focus on analytics developed solely from the physical movement of people, for example, between product areas within the retail environment. No insight is offered on the consumer's online focus, nor specific products. Offerings of this nature are of interest only to large venues with multiple zones. Typically these solutions require proprietary infrastructure and significant retailer/venue investment (putting them out of reach of small venues and pop-up shops or event spaces).

### Network Traffic Analytics

Analysis of network and web traffic analysis are applications used for operational management as well as marketing, commonly web filtering and Search Engine Optimisation. The focus of network analytics focuses on security and performance at a macro geo-location level, while web analytics have a business-driven purpose and are typically positioned at the web server level, whose with a worldwide geographic spread. There are no known services that attempt to combine the two purposes to create business intelligence at an indoor-location level.

There is a desire for a system which can provide reactive or customised content dynamically to users' portable devices based upon their physical location.

It is an object of the present invention to provide a method and system for dynamically delivering content to portable devices which overcomes the disadvantages of the prior art, or at least provides a useful alternative.

### SUMMARY OF INVENTION

According to a first aspect of the invention there is provided a method for dynamic delivery of content to a user of a portable device connected to an access point, including:
a) analysing network traffic sent from the portable device via the access point;
b) generating a profile for the user based at least in part upon the analysed network traffic and the location of the portable device;
c) matching content to the user profile; and
d) delivering the matched content to the portable device.

The network traffic may be analysed by analysing network traffic logs. The network traffic logs may be captured at one or more from the set of the access point, a router, and a firewall.

The access point may be a wireless access point.

The method may include a step of obtaining physical coordinates for the portable device and wherein the profile may be generated based at least in part upon the physical coordinates. The physical coordinates may be generated outside the portable device. The physical coordinates may be processed to generate a physical journey profile for the user and wherein the physical journey profile may be used to generate the profile for the user.

The method may further including a step of obtaining inherent information about the portable device and wherein the profile may be generated based at least in part upon the inherent information. The inherent information may be user agent information.

The network traffic may includes URLs. The method may further including weighting the URLs. The URLs may be weighted using a marker database of stored weighted URLs. The weightings for the stored weighted URLs may evolve based upon use. The URLs may be weighting using a keyword database.

The step of generating a profile for the user may involve categorisation of the user into one of a plurality of predefined profiles.

The method may include a step of profiling the content prior to matching the content. This step may comprise acquiring the content and/or categorising the content. The content may be categorised into a type in accordance with a predefined list of keywords and a topic-based text classifier.

The matched content may be delivered to the portable device within a captive portal. The portable device may be forced to reactivate the captive portal via a trigger initiated at the access point. The captive portal may be reactivated by disconnecting the portable device from the access point. The triggers may include one or more from the set of zone changing, profiling changing, and user Internet activity.

The matched content may be delivered to the portable device via a notifications system at the portable device.

The matched content may be delivered to the portable device in a ranking of matched content based upon the user profile.

According to a further aspect of the invention there is provided a system comprising:
a processor;
a memory; and
a communications system;
wherein the system is configured for performing the method of the above aspect.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a block diagram illustrating a system in accordance with an embodiment of the invention;

FIG. 4: shows a block diagram illustrating a system in accordance with an embodiment of the invention;

FIG. 5: shows a block diagram illustrating a user profiling system in accordance with an embodiment of the invention;

FIG. 6: shows a block diagram illustrating a hardware architecture for capturing traffic logs in accordance with an embodiment of the invention;

FIG. 7: shows a diagram illustrating a method for constructing a purchaser coefficient in accordance with an embodiment of the invention;

FIG. 8: shows a block diagram illustrating a content profiling system in accordance with an embodiment of the invention;

FIG. 9: shows a block diagram illustrating the collection of content in accordance with an embodiment of the invention;

FIG. 10: shows a diagram illustrating a hierarchical tree structure for organising keywords in accordance with an embodiment of the invention;

FIG. 11: shows a diagram illustrating weights assigned between keywords and topics in accordance with an embodiment of the invention;

FIG. 12: shows a diagram illustrating the assignment of weights between keywords and topics using a training set of documents in accordance with an embodiment of the invention;

FIG. 13: shows a diagram illustrating the classification of documents to topics using keyword detection and keyword/topic weighting in accordance with an embodiment of the invention;

FIG. 14: shows a diagram illustrating the number of content topics pages opened by different profiles in accordance with an embodiment of the invention; and

FIG. 15: shows a block diagram illustrating an authentication system in accordance with an embodiment of the invention.

### DETAILED DESCRIPTION OF PREFERRED EMBODIMENTS

The present invention provides a method and system to deliver dynamic content to portable devices.

The inventors have discovered that network traffic from a portable device can be monitored and analysed to determine information, such as behavioural information, about the user of the device. The inventors have discovered that this behavioural information can then be used to select and deliver content that might be interesting or useful to the user.

Furthermore, this behavioural information can be augmented by location information about the portable device. When deployed within a physical environment such as a retail store, the inventors have discovered that context-specific content can be dynamically delivered to the portable device which increases sales at the retail store.

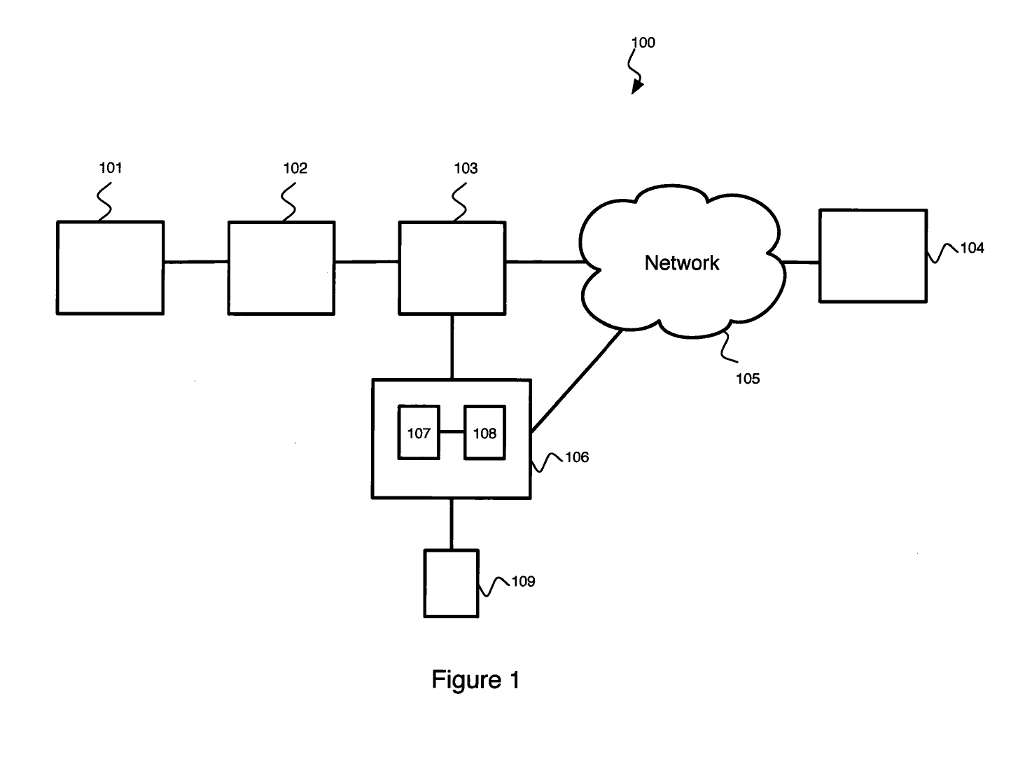

In FIG. 1, a system 100 in accordance with an embodiment of the invention is shown.

A portable device 101 is shown. The portable device 101 may be a smart-phone, tablet computer, laptop computer, or any other mobile computing device.

An access point 102 is shown. The access point 102 may be a wireless access point or a cellular access point.

A router 103 is shown. The access point 102 may be connected to the router 103 and the router 103 may be connected to external content 104 via a networking communications infrastructure 105 which may include the Internet. The router 103 may be connected to the external content 104 via a firewall or proxy (neither shown).

It will be appreciated that in some configurations the access point 102 and router 103 may be the same device.

A server 106 is shown. The server 106 comprises a processor 107 and a memory 108, and is connected to at least one database 109. The server 106 may be connected via a networking communications infrastructure 105 to external content 104. The server 106 may be connected to the router 103 and configured to monitor network traffic between the router 103 and the portable device 101. The server 106 may be configured to monitor network traffic by retrieving network traffic logs. In alternative embodiments, the server 106 may be connected to the firewall or proxy and monitor network traffic passing though those apparatus. The server 106 may also receive location information about the portable device 101. The location information may be determined at the access point 102 or at other apparatus separate from the portable device 101, for example, using triangulation. The location information may be processed to calculate a journey path or profile for a user of the portable device 101.

The server 106 may also be configured to receive external content (for example, from social media servers, from third party web servers or from proprietary databases) or local content stored at the database 109 and to classify the content based on keywords within the content. The server 106 may receive content periodically using a fetch engine.

The server 106 may also be configured to analyse the network traffic and location information from and about the portable device 101 to assist in generating a behavioural profile for the user of the portable device 101. The server 106 may analyse the network traffic by analysing the network traffic logs. The server 106 may further utilise the location information and other inherent information about the portable device 101, such as a user agent of the browser executing on the portable device 101, to assist in generating the behavioural profile.

The server 106 may be further configured to match classified content to a user based upon a generated behavioural profile and to deliver the content to the portable device 101 of the user via the access point 102.

It will be appreciated that different network configurations can be envisaged. For example, the server 106 may monitor network traffic and/or location data via the access point 102, router 103, firewall, or proxy. Furthermore, different functions of the server 106 may be performed by a plurality of apparatuses, which may be co-located or deployed within a distributed architecture.

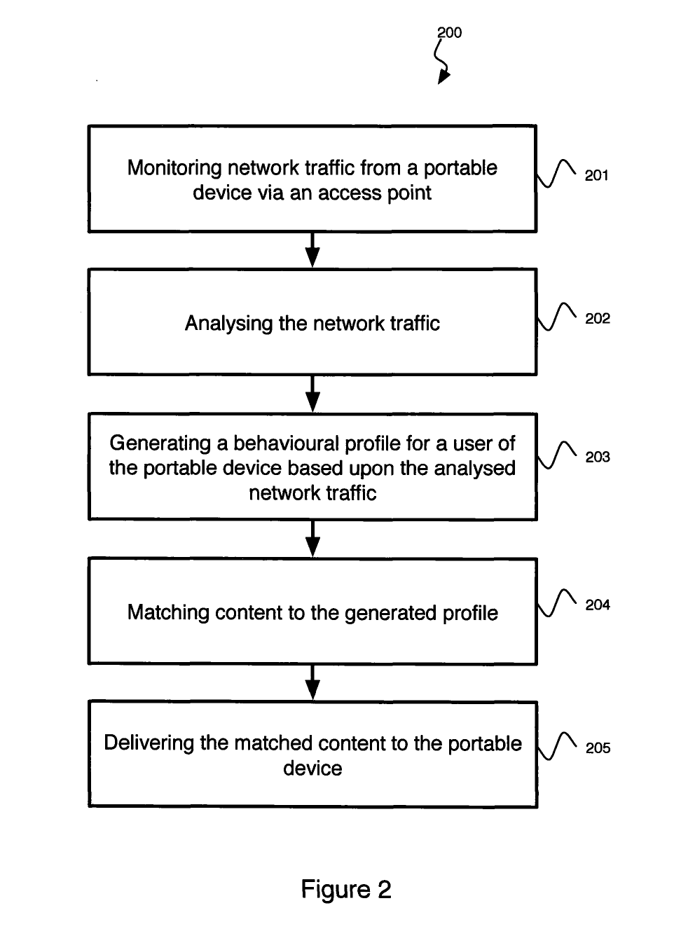

With reference to FIG. 2, a method 200 in accordance with an embodiment of the invention will be described.

In step 201, network traffic sent by a portable device 101 via an access point 102 may be monitored. The network traffic may be monitored via the access point, via a router 103 connected to the access point 102, or via an intervening firewall or transparent proxy. The network traffic may be monitored by retrieving network traffic logs from the access point 102, router 103, firewall or proxy.

The network traffic logs may comprise Internet traffic information such as IP addresses or URLs.

In step 202, this monitored network traffic is analysed by the server 106. The server 106 may analyse the monitored network traffic by analysing the network traffic logs. The analysis may include the cleaning or filtering of the logs to remove extraneous information. For example, only web-page URLs might be filtered for use.

In step 203, the analysed traffic is used to generate a behavioural profile about the user of the portable device 101. Location information and/or inherent information about the portable device 101 (such as the user agent of a browser at the portable device 101) may also be used to assist in generation of the behavioural profile. The location information about the portable device 101 may be determined at the access point 102 or at another apparatus separate from the portable device 101. The location information may provide granular detail about the portable device 101, such that the location of the portable device 101 can be tracked through a venue. For example, triangulation may be utilised to determine the location information. The location of the portable device 101 over time can be used to generate walking speed, and duration of a user's trip—a journey profile or path. This can be mapped to, for example, the type of shopper that the user is. This can then be used to assist in generating the behavioural profile for the user.

The behavioural profile may be calculated from a plurality of weighted factors. The weighted factors may be calculated from markers analysed within the network traffic. The markers may be predefined weightings allocated to a plurality of URLs combined with keywords identified within an intercepted URL.

The user agent information about the portable device 101 may be detected within the monitored network traffic or by a captive portal for the access point 102.

In step 204, the behavioural profile is used to match content to the user.

The content may first be acquired from one or more sources. The sources may include a local database 109, and an external database or servers accessible via a network 105 and/or Internet (for example, social media servers or venue content servers). Content may be acquired periodically from the one or more sources. That is, the content may be periodically refreshed.

The content may be classified in accordance with a classification system. For example, keywords within the content may be extracted and used to classify the content into one or more of a plurality of topics. The classification system may be pre-trained with documents and topics to enable keyword extraction and classification.

The content may be matched to a behavioural profile based upon historical content access by similarly profiled users.

In step 205, the matched content is delivered to the portable device 101.

The matched content may be delivered to the portable device 101 by reactivation.

One form of reactivation includes the step of disconnecting the device 101 from the access point 102 forcing a reconnection. During the reconnection to the access point 102, a captive portal can be delivered to the portable device 101. The captive portal can be configured for that portable device 101, based, for example, on a unique identifier for the device such as MAC code, to deliver the matched content.

Alternatively, some intelligent routers 103 can trigger redirection to a connected device 101 to an “advertisement” page. The matched content can be displayed within the “advertisement” page.

Alternatively, some communications chipsets within portable devices 101 may support being pushed new content from the access point 102. The matched content can be pushed in this way.

It will be appreciated by those skilled in the art that different methods of delivering the content to the portable device 101 can be envisaged.

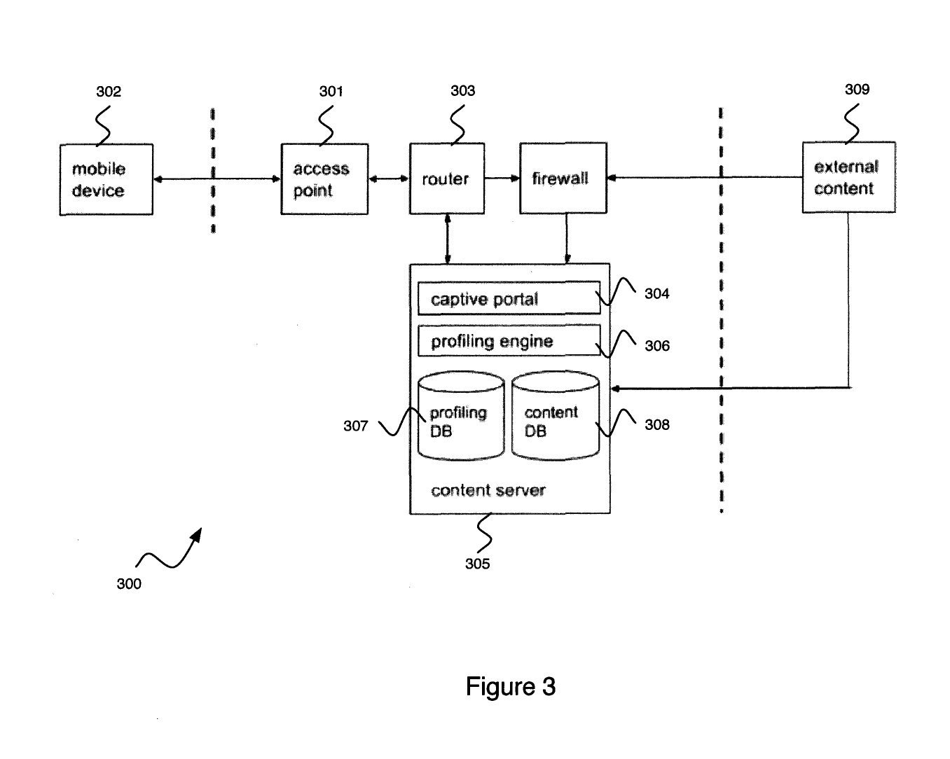

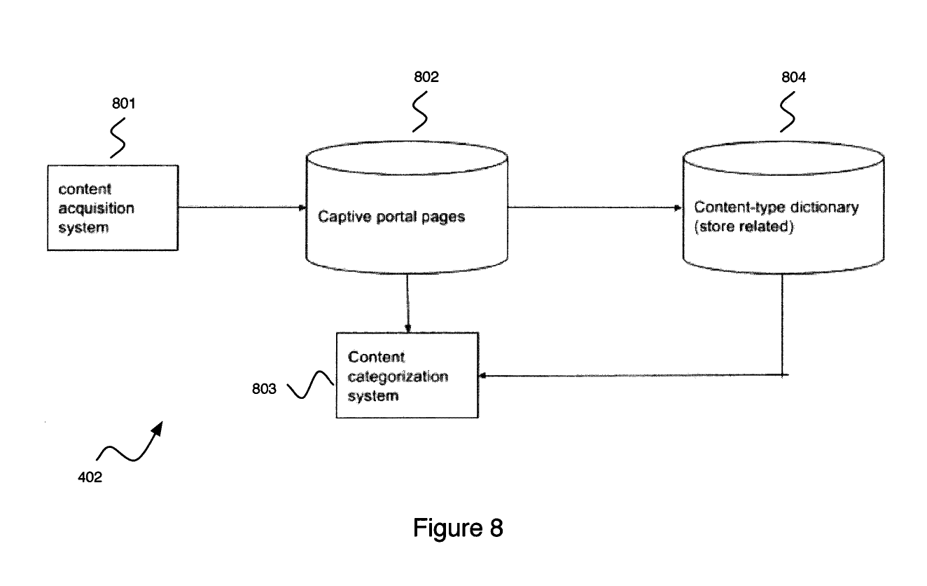

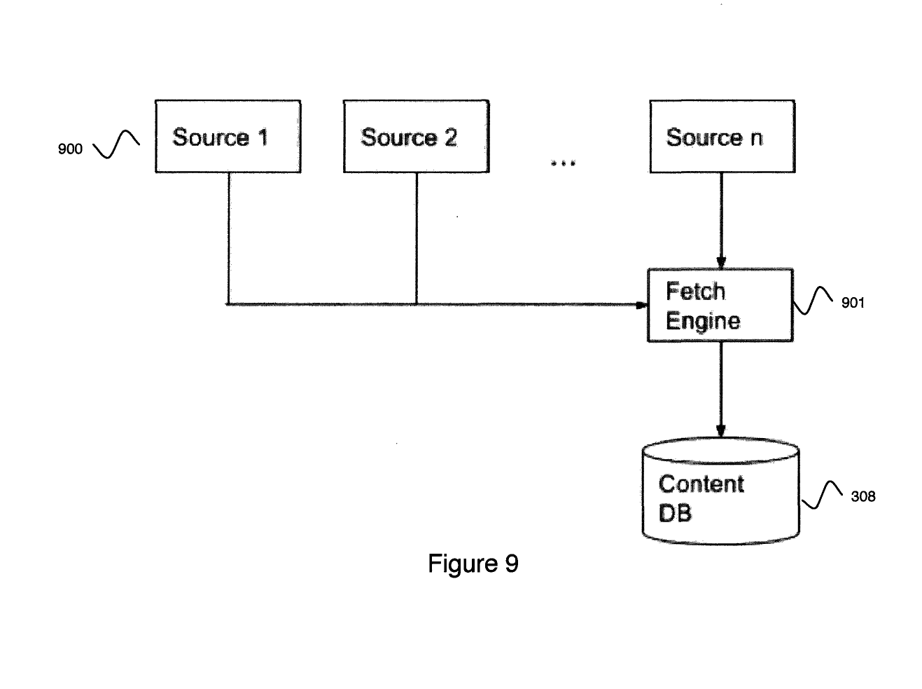

One embodiment of the invention will now be described with reference to FIGS. 3 to 18.

Referring to FIG. 3, this embodiment is a system 300 which provides dynamic content such as web content inside a Wi-Fi captive portal or via an alternative content notification system in accordance with the user's online behaviour.

The system 300 comprises an access point 301 to which the user is connecting, via their mobile device 302, in order to access the Internet via a WLAN (Wireless Local Area Network). After connecting to the access point 301, the user is redirected, via a router 303, to a captive portal 304, provided by a content server 305, where the user authenticates themselves to continue Internet activity. There may be user/password authentication, the user may connect anonymously without personally identifying information, or the user can also be recognised by name if the connecting device is paired to a named user account. Where no authentication credentials are provided, the system 300, therefore, is non-invasive.

The system 300 records the user's activity inside the captive portal 304 (when the user is navigating inside the local website) or outside (when the user is browsing external websites) and, based on the activity, a user profile is created by a profiling engine 306 and stored at a profiling database 307. The content of the captive portal 304, or content notification, is generated, from a content database 308, dynamically based on the created profile. The content database 308 can be constructed using external content 309. A mechanism to re-engage the user on the WiFi network can serve relevant captive portal pages or initiate a notification to the user's device 302, for example, when the system 300 determines the user is interested in a particular product from websites browsed by the user. The content may be ranked based upon the user's profile in order to prioritise content most relevant to the user.

The system 300 may be provided for use in relation to users inside venues e.g. retail stores—offering, for example, free Internet access to visitors/consumers together with personalised content (with or without being known by name), targeted to a user's profile that is generated dynamically, based on their physical location and online activity.

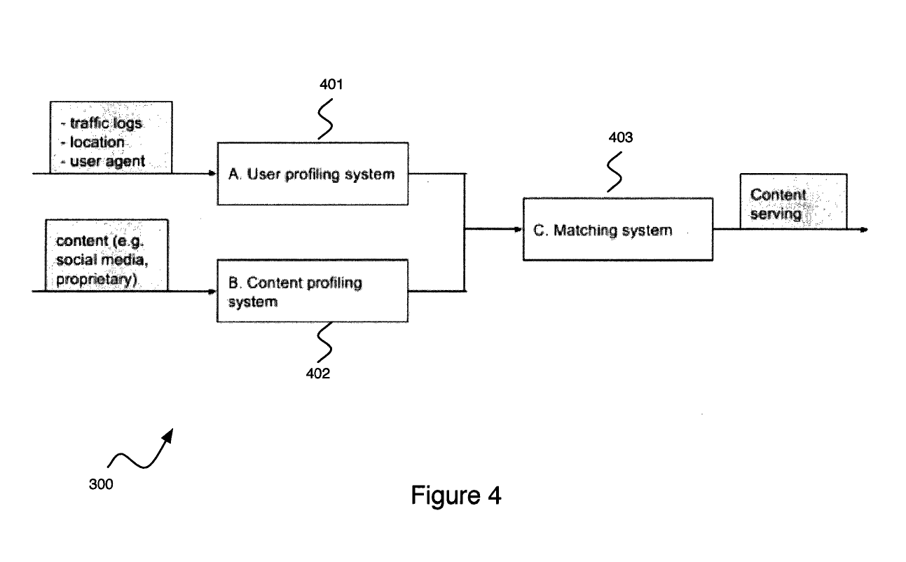

Referring to FIG. 4, a block diagram of the system 300 will be described.

The system 300 comprises a user profiling system 401 configured to receive traffic logs from the mobile device's 302 interaction with the access point 301, the location of the mobile device 302, and the user agent information of the mobile device 302 (i.e. the type of device, type of browser, etc.).

The system 300 also comprises a content profiling system 402 configured to receive content, for example, from the Internet such as social media, third party content or from proprietary databases, such as databases prepared by the retailer, manufacturer, or the provider of the system 300. The third party content may approved for use by the retailer, manufacturer, or the provider of the system 300. For example, the third party content may be a fashion media outlet who has been approved because the outlet regularly publishes advertorials for the retailer.

The system 300 further comprises a matching system 403. The matching system 403 is configured to select and match content processed by the content profiling system 402 with the user profile generated by the user profiling system 401. This content can then be served by a content serving system to the mobile device 302.

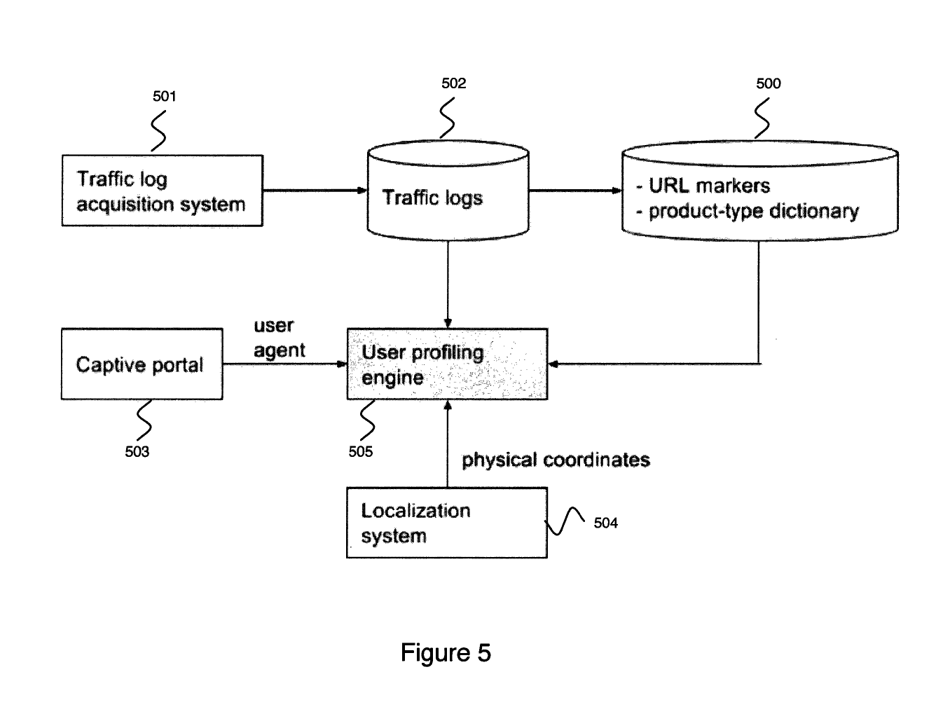

Further details on the user profiling system 401 will now be described with reference to FIG. 5.

### 1. User Profiling System 401

The user profiling system 401 is used to help determine the content for the captive portal 304 or notification to their device 302 according to the user's online activity. The online activity may include online traffic sent/received by applications used on the user device 302 and which external websites are browsed all while being connected to the access point 301.

The user profiling system 401 uses a set of “markers”, stored in a markers database 500, which are relevant to the venue. These markers may be generated from URL domains or IP addresses accessed by users during browsing at the venue or pre-defined by the venue as being remarkable online destinations. This set of markers can be used by the system 401 to categorize the user profile and the user's disposition to the venue's content.

The markers database 500 may be first initialised by a markers database initialisation component to train the user profiling system 401. The training process will be continued by a markers database calibration component where the user profiling system 401 will improve in accuracy over time and with greater volumes of user data.

The user profiling system 401 includes a traffic logs acquisition system 501 which obtains and stores network traffic logs within a traffic log database 502.

User-agent information is obtained by the user profiling system 401 from, for example, a captive portal 503 accessed by the user mobile device 302 or syslogs provided by a transparent proxy.

Physical coordinates of the mobile device 302 may be obtained from a localization system 504.

The user profiling system 401 also includes a user profiling engine 505 which uses the relevant captured data for a user and the markers database 500 to profile a user by assigning a coefficient value to the user.

The data acquisition systems, marker database initialisation and calibration components, and user profiling engine 505 will now be described in more detail:

### 1.1. “Marker” Database 500 Initialisation Component

This component generates the markers database 500 for a venue. The venue owner may specify and map relationships of URL markers with the user profiling system 401 manually on setting up the system. Using these initial URLs the venue owner may create a relationship to the physical zone context within the venue and the generalised demographic of a user subject, such as likelihood-of-purchase or gender.

The marker database 500 is a reference data set that is defined according to the venue's industry and segment profile. For example, in retail, segmentation can be made based on product categories like fashion, electronics or sports. Markers are website domains that contain content either (1) related to the venue owner e.g. retail store products (such as competitor websites or brand marketing/promotion advocacy websites) or (2) content that is unrelated to the venue owner e.g. for a retailer this might be a news or sports website that relates to general news rather than product or specific news.

The markers database 500 for a venue can be pre-populated initially by the venue owner with relevant URLs e.g. related stores or competitors, and initial weightings. This initialisation may be stabilised during an initial time period of data acquisition within the venue. During this period the system 300 observes and analyses the external websites opened by the users. This process can be used to further calibrate the system 300 (as described in 1.3).

### 1.2. Data Acquisition

Three types of data are captured for use in creating a user profile by the user profiling system 401:

### 1.2.1 Traffic Logs Acquisition:

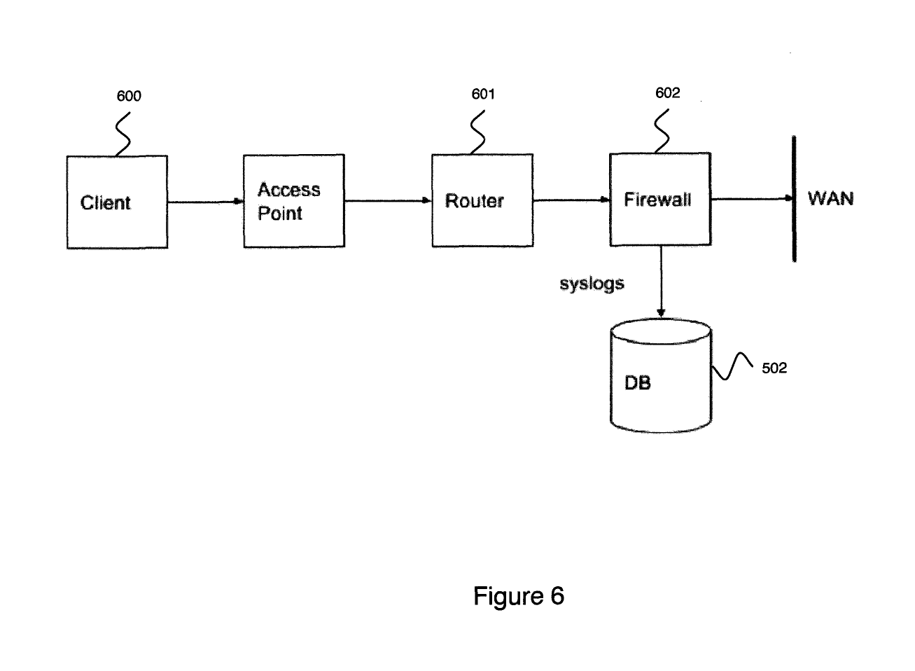

With reference to FIG. 6, the acquisition of traffic logs will now be described.

It is possible to determine online activity using the traffic logs for a mobile device 600 within the WLAN issued by a router 601, firewall 602 or a transparent proxy.

When traffic logs are obtained from the router 601, they may be extracted from syslogs generated by the router 601. In some implementations, the traffic logs may contain only the source and destination IP addresses (IP address traffic logs) rather than the full URLs (URL traffic logs).

In a preferred embodiment, traffic is logged from a firewall 602 or from a transparent proxy, because these apparatus provide access to full URLs which can provide more useful information to the system 300, particularly when the opened webpage has a ‘friendly URL’. Within the context of this description, a friendly URL is a web address that includes words that describe the content of the webpage.

### (1) Example of IP Address Traffic Logs:

Start http session: initiator (192.168.88.214:59379)—responder (185.31.18.143:80)

### (2) Example of URL Traffic Logs:

192.168.88.214 Accessed URL

195.59.150.57:http://polling.bbc.co.uk/radio/realtime/bbc_radio_two.jsonp

Syslogs can be saved into the database 502 using a tool such as rsyslog. Syslogs include many different types of logs including security alerts, warnings, and notifications. It is preferred that, to reduce load, only traffic logs served by the router 601/firewall 602 are saved to the database 502.

Preferably unnecessary logs generated by the loading of .css, .js, jpg, etc. files are filtered out. The filtering can be accomplished by updating/configuring an existing syslog daemon or to create triggers in the database 502, before the logs are saved in the database 502. In the end, the result will be a clean syslog database 502 with webpage URLs.

The difference between user initiated Internet activity and the activity generated in the background by native mobile device applications can also be distinguished:
(1) The logs may be analysed to generate a virtual journey that the user makes in their browser (within one web property or between web properties); and
(2) The logs may be analysed to extract information from traffic generated provided by applications running in the background on the mobile device 302, such as email, social media apps, games, financial apps. Detecting the existence of these applications running in the background of the mobile device 302 can be used improve the profiling of the user.

The signature of these applications can be determined and used to identify the existence of the applications on the mobile devices.

### 1.2.2. User-Agent Acquisition:

The User Agent for the browser is captured into a database from the User's interaction with the Captive Portal 503. The User Agent is an identifier comprising various information about the browser that the user is using. It can indicate the following information: compatibility with browser standards, details of the system in which the browser is running, the platform the browser uses, and further browser platform details. The User Agent is contained within the header for HTTP requests made by the browser on the mobile device 302.

The User Agent provides the ability to identify the mobile device brand and operating system version. This may be useful to help profile the user from a social segmentation point of view. The web browser identification within the User Agent may also reveal the user's language preference, contributing to further segmentation of the user's profile. The User Agent can be captured by the Captive Portal 503 website or may be extracted from certain types of traffic logs. Some routers are also able to provide the User Agent that initiates the HTTP request, if a transparent proxy is used.

For example, an interesting metric regarding the platforms used by users reveals that the average online purchase order from iOS users was estimated to be nearly twice that of Android users. Therefore, the iOS users can be assigned a higher device profile factor within the system 300:

| Description | iOS device | Android device |
|---|---|---|
| Device factor (Fd) | 0.66 | 0.33 |

### 1.2.3. Physical Coordinates Acquisition (Within the Venue):

Location data of a user within a venue can provide insight into the visit mission of the venue visitor, e.g. in a retail use case, mission shopping for targeted products versus window shopping for entertainment. The user's physical journey inside the store may also provide the ability to identify the interest of the mobile device owner in a particular zone which can be linked to a product category.

The system 300 stores the physical position inside the venue for each individual mobile device 302 which can be used to create a representation of the journey path and speed of a user. This can be accomplished using known presence detection software that uses triangulation of a device based on relative signal strength indication to generate instantaneous x,y coordinates of a user on the floor-plan of a venue.

Some presence detection software can capture physical positions of a mobile device while the mobile device 302 is probing for WiFi networks but has not yet connected. Once the mobile device 302 has authenticated at the access point and is provided an IP address, the previously captured physical positions of the mobile device 302 can be used in conjunction, perhaps, with later captured positions to help generate the journey path and speed of the user.

By capturing the user's locations at specific time intervals, the trip duration and walking speed inside the venue can be calculated. Dwell points, or stationary periods can also be identified which will indicate the user dwelling at a point of interest, in a retail venue this might be a product category where the user is inspecting goods or a waiting line to purchase goods at the cashiers. Overlaying a planogram, or internal venue map, establishes a specific relationship between location and point of interests. Granular detection of locations may be provided by a spatial coordinate system.

This information can be analysed, as shown in the table below, to categorise the user into one of three shopping behavioural types:
1. Quick: short time, small area, slow walk, high-spending speed, very efficient.
2. Fill-in: medium time, medium area, average spending speed, modest efficiency
3. Stock-up: long time, large area, fast walk, low-spending speed, lowest efficiency

| Description | Quick | Fill-in | Stock-up |
|---|---|---|---|
| Walking speed (ft/s) | 0.52 | 0.66 | 0.98 |
| Trip duration | 13.4 | 18.5 | 25.3 |
| Dollars/min | 1.88 | 1.32 | 1.23 |
| Profile factor (Fp) | 0.75 | 0.50 | 0.25 |

A physical journey factor (Fp) can be assigned to each of these types. This physical journey factor (Fp) can be used to contribute to the general profile user.

### 1.3. “Marker” Database 500 Calibration Component:

URL markers and keywords from web pages are identified in user activity and analysed to adjust the weightings of the reference data in the Marker database 500. This database 500 continues to grow over time and with the volume of user activity. The precision of the weightings will correlate more accurately with user profiles as more data is analysed.

### 1.3.1. URL Markers:

URL markers are set and moderated by the venue owner to define a weighting of relevance to their business and users (as in 1.1). Domain names can be extracted from logs captured during the calibration period and referenced against a core marker database to determine their relative relevance to the venue, e.g. retail store. Each such identified domain is saved inside the database and a “weight” parameter is assigned according to its relevance to the venue, using values between 0 (not relevant) to 1 (most relevant). This “weight” will be used to modify the user profile based on pages visited by the user.

For example for a fashion retailer, a website with similar content will be marked with 0.90 relevance while a sport online magazine will be marked as 0.10 relevance.

### EXAMPLE

http://www.asos.com/Women/Dresses/Prom-Dresses/Cat/pgecategory.aspx?cid=11152&WT

| Id | Domain | Weight factor (W) |
|---|---|---|
| 1 | www.asos.com | 0.90 |
| 2 | www.skysports.com | 0.10 |
| 3 | www.theguardian.com | 0.30 |

However, a retailer may sell both fashion and sporting goods categories, and may initialise a low weighting to a general news website as it may not be relevant to demonstrate shopping behaviour. While a sub-section of the website dedicated to fashion trends may stimulate a relationship with a shopper in a store, an article about sports is unlikely to stimulate sporting good shopping behaviour (despite an article potentially containing language mentioning sporting goods or reference to a non-product “offer”).

Example of a URL for an article from the fashion sub-section of a general news website:
http://wwvv.theguardian.com/fashion/gallery/2014/may/06/summer-party-dresses-25-of-the-best-in-pictures

Example of a URL for an article from the sports sub-section of a general news website:
http://www.theguardian.com/sport/2014/may/07/team-sky-geraint-thomas-tempted-rival-cycling-offers

### 1.3.2. URL and Web Page Keywords—Venue's Product-Type Dictionary:

If the visited website is URL friendly, additional information can be extracted from the URL and the web page, such as the product category, product attributes, target gender. Where this information is a keyword within a dictionary compiled for the venue, the keyword may be used to alter the weight of the URL markers. The pool of keywords (or dictionary) can initially be extracted from the venue owner's online content like social media posts or articles (together with variants). The dictionary may be continuously updated.

Example of a friendly URL, with identified keywords underlined: http://www.clothingattesco.com/men/shoes-i-boots/icat/mens-footwear?utm_source=website&utm_medium=clothinglink&utm_campaign=m n-footwear

| Product-type | Product-type Keywords |
|---|---|
| Lingerie | lingerie, underwear, bras, brief |
| Shoes | shoes, footwear, boots |

From the URL above, the system 300 can identify that the user is interested in a particular product that is relevant for a fashion store, and the system 300 can approximate the gender and age of the subject, as defined in the initialisation phase of the markers database 500.

The occurrence of these product-type dictionary terms will affect the purchase likelihood percentage in accordance with the following equation:

Wurl=W(base)+Min(N,M)*(100−W(base))/M

where
N=number of keywords identified in the URL's dynamic parameters zone
M=max number of dynamic parameters (topic, subtopic, product) or more.
Wbase=weight for the root URL

For example, the theguardian.com might be assigned a weight of 0.2 because it is a newspaper. So the W(base)=0.2. But the webpage URL may contain two relevant keywords, like fashion and dresses. Therefore, the final weight of the webpage URL will be: 0.2+2*0.8/5=0.52, if M=5.

In other embodiments, the model could be further enriched by further analysis:
(1) URL page keyword identification can be further enriched by analysing a URL's meta data, body text, hyperlinks for additional keyword extraction; and/or
(2) The relationship between physical journey, for example, travel between points of interest or dwell times in a specific physical retail product category, can be analysed in relation to the online journey. For example, a user travelling from one retail website to another then spending time on social media models the behaviour of someone who is researching and confirming interest in a product, therefore the purchase likelihood is higher than someone browsing between websites with low URL marker weights.

### 1.4 User Profiling Engine 505:

A user profile is defined as a decimal value in the interval [0,1] and is calculated based on virtual activity, considering the “weight” factors defined in (1) the URL markers database 500 and (2) the venue's product-type dictionary (1.3.2) of the webpages visited by the user.

The users are identified on the WiFi network by a unique identifier, such as the MAC address of the device 302. During a WiFi session, the user receives an IP (Internet Protocol) address that is paired with the MAC address of the device 302. The user's online activity within a session can be observed by matching the log records with the given IP. During the session, the IP will be the key identifier of a unique user.

Additional identification details can be obtained by mapping a user's mobile device 302 with a known account, such as a retail loyalty or affinity program or by use of cookies.

The profiling method described in this section will refer to a retail use case, where the objective of profiling is estimating purchase intention. However, it will be appreciated that this method can be applied to other use cases such as visitors to a museum viewing exhibits or users in a corporate network traversing a building, visiting and engaging with different organisational departments of a company.

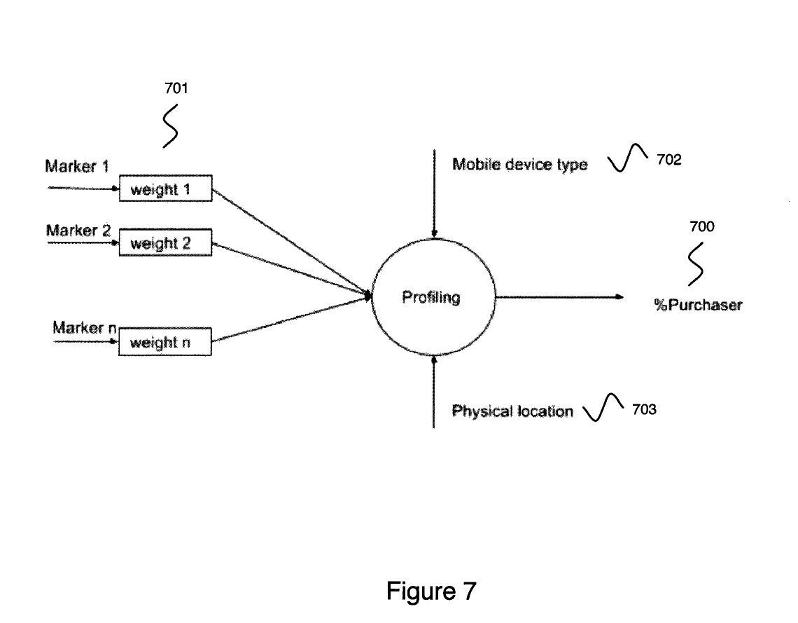

An example of the profiling system 401 in a retail case utilising the location of the user, online activity of the user and a physical journey path of the user will now be described with the user described as a “purchaser” and with reference to FIG. 7.

A purchaser factor 700, which is a weighted average of individual marker's factors 701, is calculated as follows:

$$P ( url ) = {\sum }_{i = 1}^{N} Mi * Wi / {\sum }_{i = 1}^{N} Mi$$

where
Purl=Purchaser coefficient extracted from the user's “virtual” activity
Mi=logical value corresponding to the presence of each individual marker
Wi=relevance weight of each individual marker, value assigned during the calibration of the system
N=number of markers

As described in section 1.2.2 above, the mobile device 302 has an influence on the purchaser factor 700, as follows:

Pd=Purl*Fd/2

where
Pd=Purchaser coefficient for device 302
Purl=Purchaser coefficient extracted from user's “virtual” activity
Fd=device factor 702 (e.g.: 0.6)

The purchaser coefficient 700 is influenced by physical journey parameters of the user inside the venue, such as speed or time. According to the table presented in section 1.1.3, the physical journey factor is calculated as follows:

Pp=Pv*Fp/2

where
Pp=Purchaser coefficient for physical journey
Fp=physical journey factor 703

As described in section 1.1.1, additional factors can be added to improve the calculation of the purchaser coefficient 700 based on existing apps running on the mobile device.

The system defines five engagement profile types, according to the following coefficients. A user with the highest purchaser profile is considered to have 1 coefficient, while the lowest purchaser profile has 0 coefficient.

| | | | Application: | |
|---|---|---|---|---|
| | | | Purchase | |
| Profile | | Generic | Likelihood | Application: |
| code | Coefficient | Description | Description | Description |
| P1 | 0.8-1 | definitely action | definitely | Purchaser |
| | | taker | purchaser | |
| P2 | 0.6-0.8 | definitely would | probably | Prospect |
| | | take action | would buy | |
| P3 | 0.4-0.6 | might take | might buy | Browser |
| | | action | | |
| P4 | 0.2-0.4 | probably | probably | Companion |
| | | wouldn't take | wouldn't buy | |
| | | action | | |
| P5 | 0-0.2 | definitely non- | definitely | Non- |
| | | action taker | wouldn't buy | purchaser |

Content that has been collected and profiled is matched to the engagement profile for the user as described in section 3 later in this document.

Further detail in relation to the system for profiling content will now be described:

### 2. Content Profiling System 402

The content to be delivered to the mobile device 302 via the captive portal 304 or user device notification is collected from external sources, such as social media posts or 3^{rd} party content sources, venue owner's website or a proprietary database. Content is published publicly for a specific venue owner such as news, offers, announcements or other content types. The content profiling system 402 may apply text processing techniques to categorise the content according to the content type.

The content profiling system 402 comprises a content acquisition component 801 which obtains and stores in a database 802 content for delivery via, for example, the captive portal. In one embodiment, some or all of the content may be fetched in real-time rather than obtained and stored for subsequent delivery.

The content profiling system 402 also comprises a content categorisation component 803 which utilises a classification database 804 and a text analysis system to categorise the acquired content. The text analysis procedure identifies the dictionary terms inside pages and is part of the content categorization system 803 that also assigns content-type categories to the pages according to identified terms.

Further details on both these components 801 and 803 will now be described:

### 2.1. Content Acquisition Component 801:

The content acquisition component 801 defines content sources 900 to fetch, profile and serve to users. Content can include social media posts from social media providers (such as Facebook and Twitter), and pages or data from the venue owner's website or other source specified by the venue owner. For example, social media content may be extracted from public platforms using the existing APIs offered by the source providers (such as Facebook Graph API or Twitter API). For the venue's own content sources the system can be set up to interface proprietary APIs, e.g. an eCommerce system or affiliate links product catalogue. The component extracts text and additional related info, such as images or external links, from the content. This data is stored in the content database 308 and used as a source for the captive portal website or generic notification system to enable delivery of content according to the calculated profile for the user.

The main attributes of the content that may be relevant for the acquisition component are: metadata, text, publication date, source language, images and hyperlinks.

A fetch engine 901 may be executing continuously, or periodically, in order to provide updated content.

The content acquisition component 801 will also manage content management rules, including but is not limited to: (1) logic to programmatically define the lifetime for each piece of content is managed by defining a set of campaign rules e.g. old content might be defined as inactive after a configured period of time, (2) establish relationships between content coming from different sources 900. For example match the Facebook feeds with twitter posts. This is related to the content presentation layer, for example, to present Twitter posts on a page fetched from Facebook, (3) the fetched content can also be transformed into pages, alerts, or notifications, according to the specific profile of the content. For example a Twitter feed can be associated to a product description page and can be served as an alert when the user opens a specific page.

### 2.2. Content Categorization Component 803

This component 803 categorizes the text of the content according to its content type.

Intuitive text classification is a methodology for classifying a document within a predefined category. More formally, if d(i) is a document of the entire set of documents D and {c1,c2,c3, . . . cn} is the set of all the categories, then intuitive text classification assigns one category c(j) to a document d(i).

An initial dataset is first needed that may be used to identify the categories based on relevant keywords and train an intuitive text classification engine.

| Content-type | Content-type Keywords |
|---|---|
| discount | discount code, % off, % off SALE |
| competition | win, we'll pick random, your chance |

Several steps must be applied in order to identify the correct content type for each page or content, including: defining the content-types (i.e. categories or topics), defining the venue-related dictionary, and applying text analysis techniques to assign the correct category.

### 2.2.1. Define Content-Type Categories (or Topics)

This step involves the assignment of keywords for a plurality of topics. For example, in a retail case, the topics might be: offer, news, product info, cross-marketing.

Each individual topic is represented by a group of keywords. The keyword group is a list of words, or syntagms, which are related to a specific topic of the document. This group of keywords, or dictionary, is manually trained using a collection of documents. Not all of the words presented in a document can be used in order to train the classifier, such as auxiliary verbs, conjunctions and articles. These words are called stopwords.

For example, a list of keywords like “get free”, “voucher”, “% off”, “sale” placed inside a fashion-like document can indicate that the document is related to an offer topic. It is also possible that a keyword can indicate several topics.

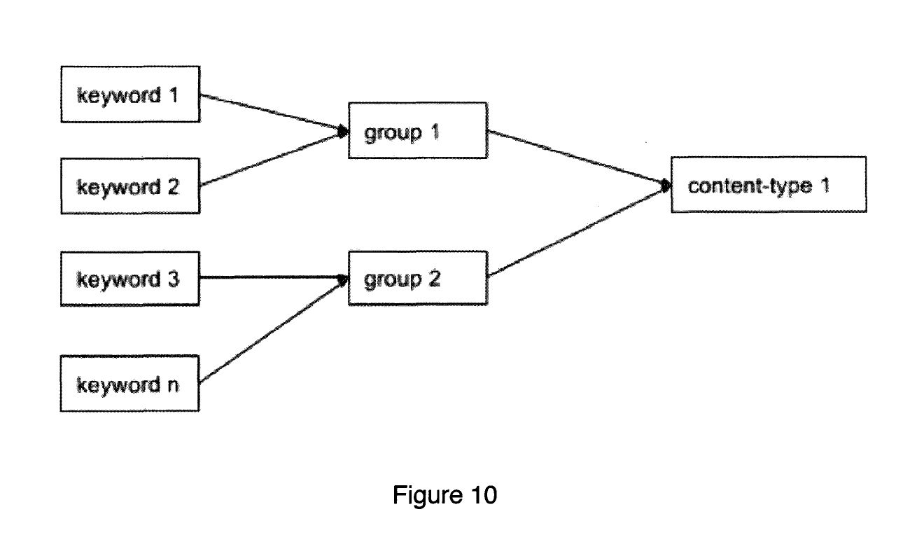

The topics may be organized in a tree structure as shown in FIG. 10. When a tree structure, or hierarchical topic dictionary, is used after the individual topics are identified, there is a second process of propagation topic weights up the tree.

An exemplary tree structure is shown below:

```
Product info [content-type 1]
  Accessories[group 1]
  Belt[keyword 1]
  cap[keyword 2]
  watch[keyword 3]
Footwear[group 2]
  shoes[keyword 1]
  boots[keyword 2]
```

In the simplest case, the weight of a topic related to a document is the number (frequency) of words from the corresponding word list, found in the document.

### 2.2.2. Topic Based Text Classification

The page/content is then classified into one or more of the defined categories using a classification system. To classify the content, text analysis techniques is first applied to identify the dictionary terms inside page content.

There are two different types of classification that may be used. The first is “Hard Classification” when the content is classified within only one topic. The other, where the content is classified within multiple topics is called “Ranking Classification”.

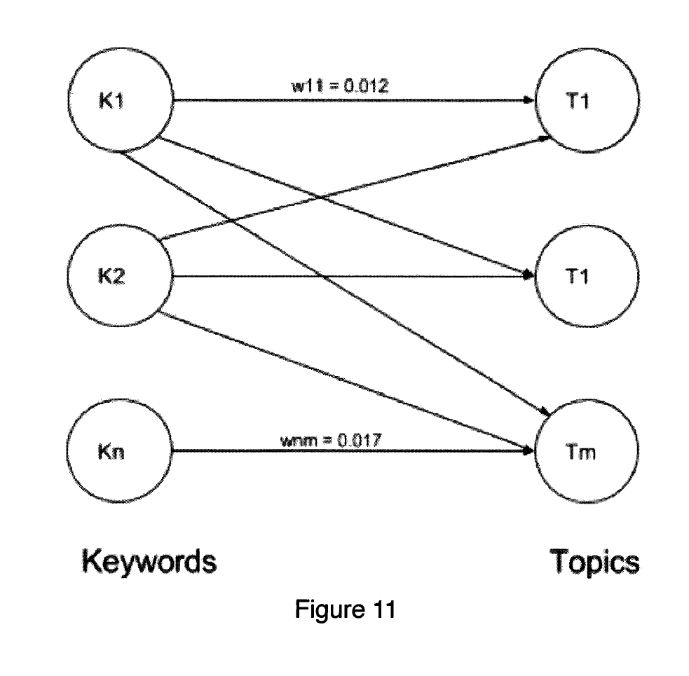

There are also several text analysis techniques that may be used including: machine learning and dictionary-based approaches:
a) The machine learning techniques differ in the approach adopted: decision trees, naive-Bayes, rule induction, neural networks, nearest neighbours, and lately, support vector machines. The three main standard algorithms are: Naïve Bayes, Support Vector Machine or Maximum Entropy.
b) Using a custom dictionary, a text analysis process is applied in order to extract the category types from individual terms. This process may use a lexicon and a dictionary of words mapped to their semantic value. Some numeric weights can be used by within the process to define the quantitative measures of relevance of the words for topics as shown in FIG. 11.

### Training the Classification System

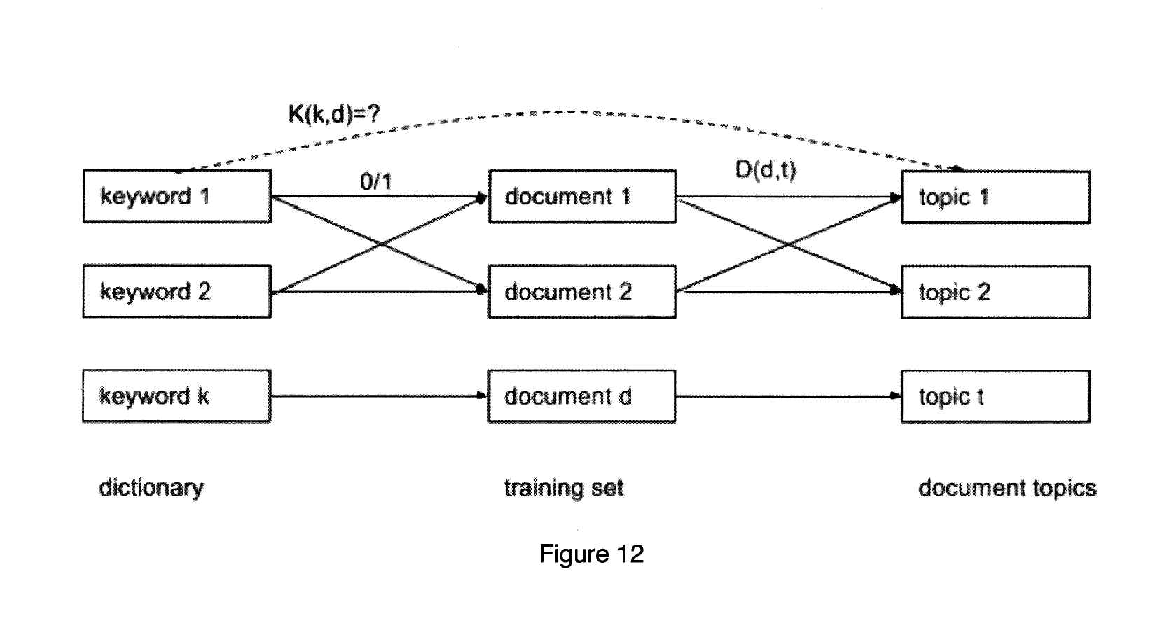

Content is categorised in one or more categories and each category will have a calculated weight as a sum of individual weights. The weight of each link (relevance weights) is calculated during the training process, when the training documents are manually assigned to one or more topics as shown in FIG. 12.

$$K ( k , t ) = {\sum }_{i = 1}^{M} D ( i , t ) * N ( k , i ) / {\sum }_{i = 1}^{M} N ( k , i )$$

where
D(i,t)=relevance weight of the document i to the Topic t (manually assigned)
N(k,i)=number of occurrences of keyword k inside the document i
W(k,t)=weight of the keyword k for the topic t
M=number of training documents

### Running the Classification System

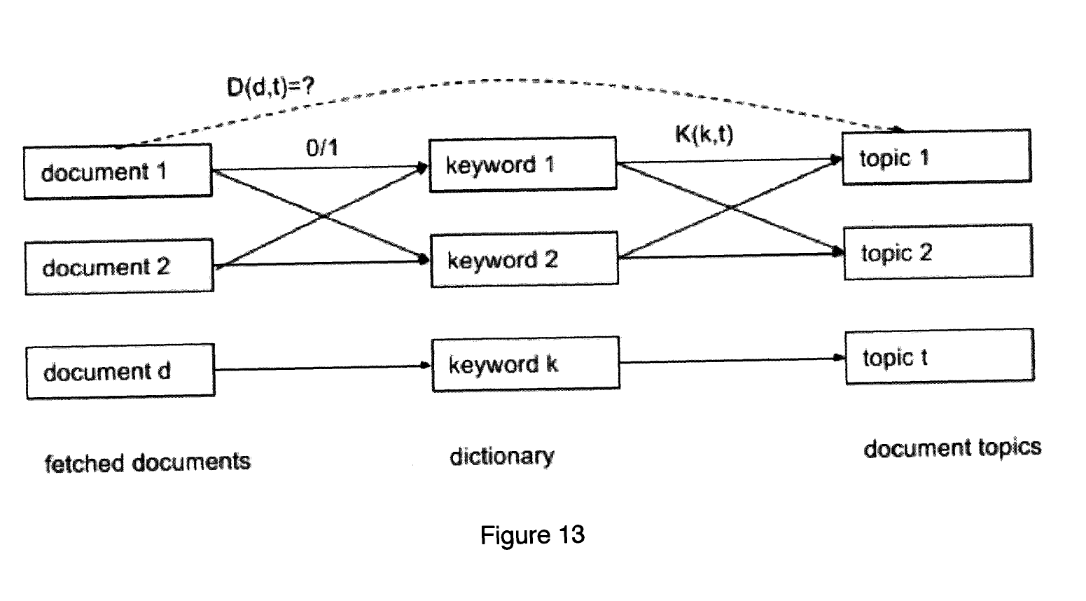

After the classification system has been trained and the relevance weights have been assigned to each link between the keyword and topic, in order to calculate the relevance of each document for each topic as shown in FIG. 13, the following formula is used:

$$D ( d , t ) = {\sum }_{k = 1}^{M} K ( k , t ) * N ( k , d ) / {\sum }_{k = 1}^{M} N ( k , d )$$

where
D(d,t)=relevance weight of the document d to the Topic t
K(k,t)=weight or the keyword k for the Topic t
N(k,i)=number of occurrences of the keyword k inside Document d
M=number of keywords detected inside Document d

Once the user has been profiled and content has been classified, the content is matched for delivery to the user in accordance with a matching system. Further detail on the matching system will now be described:

### 3. Content Matching System 403

The user profile may change during a visit at a venue. As a user makes their physical journey, the context of the physical surroundings and engagement with their mobile device 302 provides input to the user profiling system 401 to recalculate their profile. As the user's profile is dynamic, content will be served dynamically based on matching content interest.

Providing the most relevant content to user according to their calculated profile is based on a content matching or recommendation system. The content matching system 403 ranks content in order based upon the particular profile calculated for the user. It can be seen that the top ranked content is determined most relevant for the profile of the user. The ranked content may then be served to the user in accordance with a content method described in relation to section 4 below, for example, via a captive portal 304 or other local mobile device delivery method e.g. IEEE GAS.

The content matching system 403 will be implement as a learning system that evolves according to a user's behaviour (decisions). A “purchaser” user that clicks on a specific topic page will modify the corresponding weight for the ranking.

For example, a learning algorithm that may be applied is Artificial Neural Networks algorithm (ANN) that can be used to model the relationships between inputs (purchaser levels) and outputs (content category types). The neural network possesses knowledge which is contained in the values of the connections weights. Modifying the knowledge stored in the network as a function of experience implies a learning rule for changing the values of the weights. Information is stored in the weight matrix W of a neural network. Learning is the determination of the weights. Following the way learning is performed, an adaptive network is used, being able to change the weights. Unsupervised learning method can be used, since the User interactions inside the captive portal influence the system and in this way the system adjusts the weights.

An initial training of the system is also possible (supervised learning). In order to train a neural network to provide specific topics for particular profile types, the weights of each unit must be adjusted in such a way that the error between the desired output and the actual output is reduced. For a purchaser-like profile, the desired output may be represented by “discount” content type, so the training set will prepare the network to respond accordingly.

Sample of a weighted table, generated after training the system

| Topic/Profile | T1 | T2 | T3 | T4 | T5 | T6 | T7 | T8 | T9 |
|---|---|---|---|---|---|---|---|---|---|
| P1 | 0.7 | 0 | 0.1 | 0.2 | 0 | 0 | 0 | 0 | 0 |
| P2 | 0.3 | 0.1 | 0.5 | 0 | 0.1 | 0 | 0 | 0 | 0 |
| P3 | 0 | 0 | 0.1 | 0.4 | 0 | 0.5 | 0 | 0 | 0 |
| P4 | 0 | 0 | 0 | 0.2 | 0.2 | 0.3 | 0.3 | 0 | 0 |
| P5 | 0 | 0 | 0 | 0 | 0 | 0.3 | 0.1 | 0.2 | 0.4 |

According to the sample matrix, for a P1 profile client, content will be served with priority from the topics T1, T4, T3.

A “purchaser” user that will click on a specific topic page, will modify the corresponding weight.

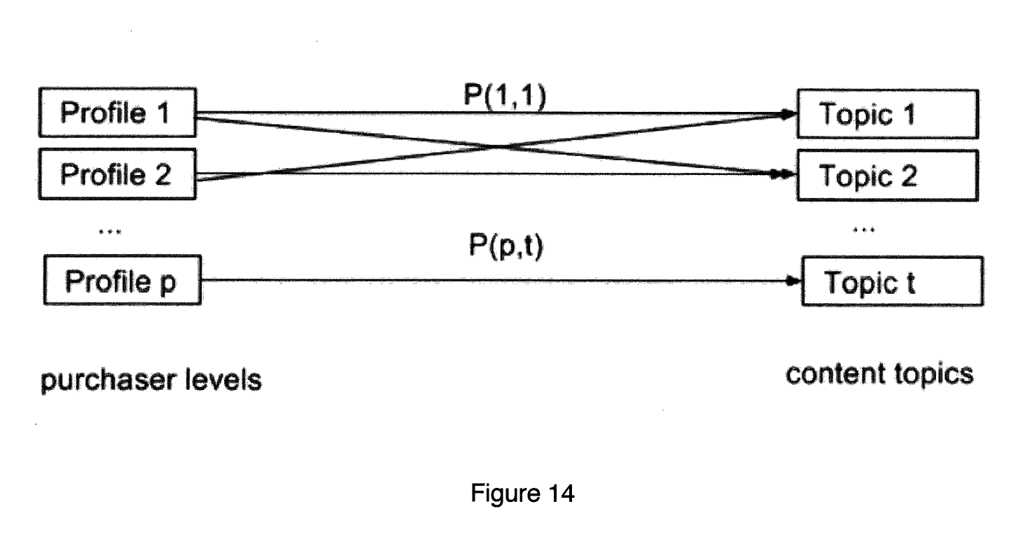

The link weight between the profile engagement types is given by the number of pages of a specific content-type topic opened by each profile engagement type as shown in FIG. 14.

$$P ( p , t ) = {\sum }_{k = 1}^{M} W ( k , t ) * N ( k , p ) / {\sum }_{k = 1}^{M} N ( k , p )$$

where
W(k,t)=logical value, 1 if k=t, 0 if k<>t
N(k,p)=number of pages of content-type Topic k opened by a Profile p
M=number or pages opened by a engagement profile p

Further detail on the serving or delivery of content to the mobile device will now be described:

### 4. Content Serving System

From an end user interaction point of view, the content is presented in a captive portal, or notification, on their device 302. The captive portal is organised in two levels: a menu page and individual pages. The order of individual pages within the menu page is determined by the ranking method described in section 3. The logical organisation of the captive portal pages are: pages are associated with a physical zone, while the zones are grouped inside store-maps (according to the venue levels). The order of the pages are determined by the content-type topic within the physical zone. For native device notifications, the handling of the presentation is managed by the native app on the device that may be at the OS or chipset level of the device.

The captive portal pages may be rendered dynamically by the content serving system based on the weight of the link between the purchaser profile and page content topic.

The content serving system can operate as a non-invasive system (i.e. no credentials are requested during the authentication process). As an extension to this system it is possible for the end user to associate to the WiFi network as a known customer, in which case, the MAC Address and customer name is stored and managed by the user profiling system 401. Interfacing with a proprietary Customer Relationship Management (CRM) system may permit association of the customer name.

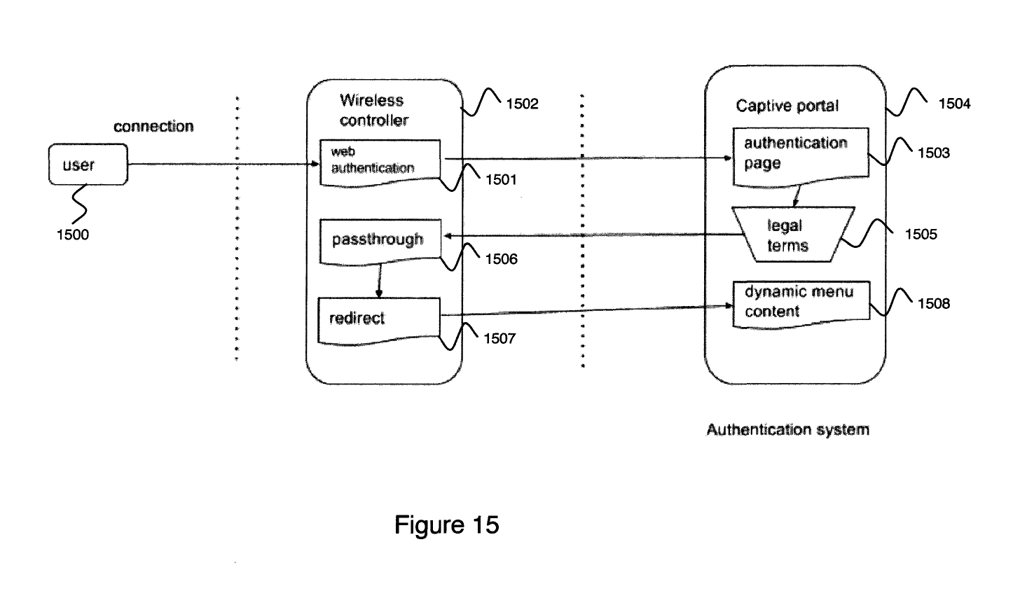

As shown in FIG. 15, the user 1500 requests web authentication 1501 via a wireless controller 1502 at the access point 301. This displays a one-click authentication page 1503 from the captive portal 1504 and the user opts in to accept terms and conditions 1505 for using the system. Once this occurs, the wireless controller 1502 authenticates the user in background using a pre-defined user or no user (passthrough authentication 1506) and redirects 1507 to the dynamic menu content 1508 delivered by the content serving system via the captive portal 304, or if the wireless network can communicate directly, with a native notification application in the device 302.

After the user profile is first calculated, a number of triggers can force a “reactivation” of the user inside the captive portal 304 by serving relevant content based on their currently updated profile.

Some triggers that can force reactivation include:
zone changing: the user moves from one physical zone to another;
profile changing: user's profile changes, for example, by navigating outside the captive portal 304 and opening external websites identified as “markers”; and
rank the URLs (competitors): user is searching for similar products on the competitors' websites.

There are multiple methods that may be used to “reactivate” a user, including:
disconnecting the user from the wireless controller 1502: the mobile device 302 will detect that the connection has been lost and will try to reactivate the connection. In this way the menu page can be served again, with updated content; or
captive portal alternative page trigger: this feature may be implemented if some routers already offer this function. The control is redirected to an alternative page in the captive portal 304, some routers refer to this as the “advertisement” page and the user is “captive” inside that page for a period of time or until the user executes an action. The contents of the advertisement page would server the same contents as the menu page in the other router variant above.

The distribution and publishing method described as a captive portal 304 can be extended to other types of mobile device 302 engagement methods, such as notification messaging that is enabled at device operating system or chipset level. For example, frameworks based on the IEEE 802.11u protocol Generic Advertising Service “GAS operates BEFORE the Wi-Fi device and the access point (AP) form an association, BEFORE the network authenticates the device and BEFORE the device receives an IP address.”

A potential advantage of some embodiments of the present invention is that content can be dynamically served to a mobile device based upon the granular location of the device (and, therefore, the user) and behavioural characteristics of the user of the mobile device. It will be appreciated that this technical advantage has several non-technical, flow-on advantages including the ability for a retail store to maximise sales by delivering relevant content to the user's mobile device such as further details about specific products items, and/or targeted sales.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for dynamic delivery of content to a user of a portable device connected to an access point, including:
a) analysing network traffic sent from the portable device via the access point;
b) generating a profile for the user based at least in part upon the analysed network traffic and the location of the portable device;
c) matching content to the user profile; and
d) delivering the matched content to the portable device.

2. A method as claimed in claim 1, wherein the network traffic is analysed by analysing network traffic logs.

3. A method as claimed in claim 2, wherein the network traffic logs are captured at one or more from the set of the access point, a router, and a firewall.

4. A method as claimed in claim 1, wherein the access point is a wireless access point.

5. A method as claimed in claim 1, including the step of obtaining physical coordinates for the portable device and wherein the profile is generated based at least in part upon the physical coordinates.

6. A method as claimed in claim 5, wherein the physical coordinates are generated outside the portable device.

7. A method as claimed in claim 5, wherein the physical coordinates are processed to generate a physical journey profile for the user and wherein the physical journey profile is used to generate the profile for the user.

8. A method as claimed in claim 1, further including the step of obtaining inherent information about the portable device and wherein the profile is generated based at least in part upon the inherent information.

9. A method as claimed in claim 8, wherein the inherent information is user agent information.

10. A method as claimed in claim 1, wherein the network traffic includes URLs.

11. A method as claimed in claim 10, further including the step of weighting the URLs.

12. A method as claimed in claim 11, wherein the URLs are weighted using a marker database of stored weighted URLs.

13. A method as claimed in claim 11, wherein the weightings for the stored weighted URLs evolve based upon use.

14. A method as claimed in claim 11, wherein the URLs are weighting using a keyword database.

15. A method as claimed in claim 1, wherein the step of generating a profile for the user involves categorisation of the user into one of a plurality of predefined profiles.

16. A method as claimed in claim 1, further including the step of profiling the content prior to matching the content.

17. A method as claimed in claim 16, wherein the step of profiling the content comprises acquiring the content.

18. A method as claimed in claim 16, wherein the step of profiling the content comprises categorising the content.

19. A method as claimed in claim 18, wherein the content is categorised into a type in accordance with a predefined list of keywords and a topic-based text classifier.

20. A method as claimed in claim 1, wherein the matched content is delivered to the portable device within a captive portal.

21-25. (canceled)

26. A system comprising:
a processor;
a memory; and
a communications system;
wherein the system is configured for performing the method of claim 1.

27. A non-transitory computer readable storage medium having stored therein instructions, which when executed by a processor of a system cause the system to perform the method of claim 1.

28. (canceled)
